(19) United States
(12) Patent Application Publication
(10) Pub. No.: US 2011/0222030 A1
(43) Pub. Date: Sep. 15, 2011

(54) IMMERSION LITHOGRAPHIC APPARATUSES

(75) Inventor: Wei-Cheng SHIU, Taoyuan County (TW)

(73) Assignee: NANYA TECHNOLOGY CORPORATION, Taoyuan (TW)

(21) Appl. No.: 12/720,609

(22) Filed: Mar. 9, 2010

(51) Int. Cl. G03B 27/52

(52) U.S. Cl. 355/30; 355/53

(57) ABSTRACT

Apparatuses for specially designed gradient immersion lithography are presented. The gradient immersion lithographic apparatus includes a radiation system providing a patterned beam of radiation, a substrate table with a substrate structure held thereon, a projection system with an optical lens element arranged to project the patterned beam of radiation onto the substrate structure, multiple layers of media of gases, liquids, or liquid crystals partitioned by moveable plates arranged in sequence between the projection system and the substrate structure, and a controller for displacement of the moveable plates to adjust relative thicknesses of the multiple layers of media.

### BACKGROUND OF THE INVENTION

1. Field of the Invention

The invention relates to immersion lithographic apparatuses to gradient immersion lithography with multiple media layers, and in particular, partitioned by specially designed moveable plates.

2. Description of the Related Art

A lithographic projection apparatus can be used, for example, for the manufacturing of integrated circuits (ICs). In general, a single wafer will contain a network of adjacent target portions (e.g., a semiconductor layer, a metal or metal containing layer, a dielectric layer, a hard mask layer, etc.) that are successively irradiated via a projection system, one at a time. In order to increase integration of semiconductor devices, it is necessary for lithographic projection apparatuses to print minimum line widths of 25-100 nm. Currently, photolithographic tools using 193 nm and 157 nm radiation, produce patterned features having a resolution (in nm), according to the well known Rayleigh equation, of R=k₁×λ/NA. In the Rayleigh equation, R is the resolution, k₁ is a constant that is dependent on which radiation sensitive material (resist) is used, λ is the wavelength of the radiation, and NA is the numerical aperture. The numerical aperture NA is determined according to the equation NA=n×sin(θ), where n is the index of refraction of the material through which the radiation passes and θ is the angle of incidence of the radiation. In order to achieve a high resolution R, it is necessary to either reduce k₁ and λ or increase the numerical aperture NA. Difficulties with using available materials to design appropriate optical lenses, however, make increasing the NA difficult. Nevertheless, when trying to increase the NA, most research focuses on increasing the index of refraction n.

One method of decreasing the wavelength of the radiation for a lithography system is to immerse a substrate in a lithographic projection apparatus in a fluid having a relatively high refractive index, e.g., water, so as to fill the space between the optical element of the projection system (lens) and the substrate. Filling the space between the optical element of the projection system and the substrate enables imaging of smaller features as exposure radiation has a shorter wavelength in fluid. Thus, in effect, the fluid may be used to increase the effective NA of a projection system.

FIG. 1 is a schematic view of a conventional immersion lithography system. In immersion lithography, the space between the projection lens and the substrate structure hold on a table is filled with a liquid. One difficulty presented by filling the space between the optical element of the projection system L1 and L2 and the substrate with a fluid 140 is that the fluid has an index of refraction between the indices of refraction of the optical element L2 and the substrate (e.g., a capping layer 130 and a photoresist layer 120 on a silicon wafer 110). Thus, a high refraction angle θ is required in the immersion lithography system. Accordingly, the fluid 140 is only able to decrease the wavelength of the radiation once, as the index of refraction of the fluid is constant throughout the space between the optical element L1 and the silicon wafer 110.

Another essential problem associated with immersion lithography is that many available high-index fluids or other types of materials are not transparent enough, such that the amount of radiation incident on the substrate is decreased dramatically post sufficient distance transportation. Accordingly, improvements in immersion lithographic apparatuses and methods are desired.

### BRIEF SUMMARY OF THE INVENTION

An embodiment of the invention provides an special designed apparatus for gradient immersion lithography, comprising: a radiation system providing a patterned beam of radiation; a substrate table with a substrate structure held thereon; a projection system with an optical lens element arranged to project the patterned beam of radiation onto the substrate structure; multiple layers of media of gases, liquids, or liquid crystals partitioned by specially designed moveable plates arranged in sequence between the projection system and the substrate structure; and a control element adjusting relative positions of the moveable plates.

Another embodiment of the invention provides an apparatus for specially designed gradient immersion lithography, comprising: a radiation system providing a patterned beam of radiation; a substrate table with a substrate structure held thereon; a projection system with an optical lens element arranged to project the patterned beam of radiation onto the substrate structure; multiple layers of media of gases, liquids, or liquid crystals partitioned by moveable plates arranged in sequence between the projection system and the substrate structure, wherein an effective refraction index of the media bridges a gap of refraction index between the optical lens element and the substrate structure; and a controller for displacement of the moveable plates to adjust relative thicknesses of the multiple layers of media.

### BRIEF DESCRIPTION OF THE DRAWINGS

The invention can be more fully understood by reading the subsequent detailed description and examples with references made to the accompanying drawings, wherein:

FIG. 1 is a schematic view of a conventional immersion lithography system;

FIG. 2 is a schematic view of an embodiment of an apparatus for immersion lithography with multiple layers of media partitioned by moveable plates;

FIG. 3A is a schematic view of an embodiment of electromagnetic placement of the moveable plates of the invention; and

FIG. 3B is a schematic view of another embodiment of mechanical placement of the moveable plates of the invention.

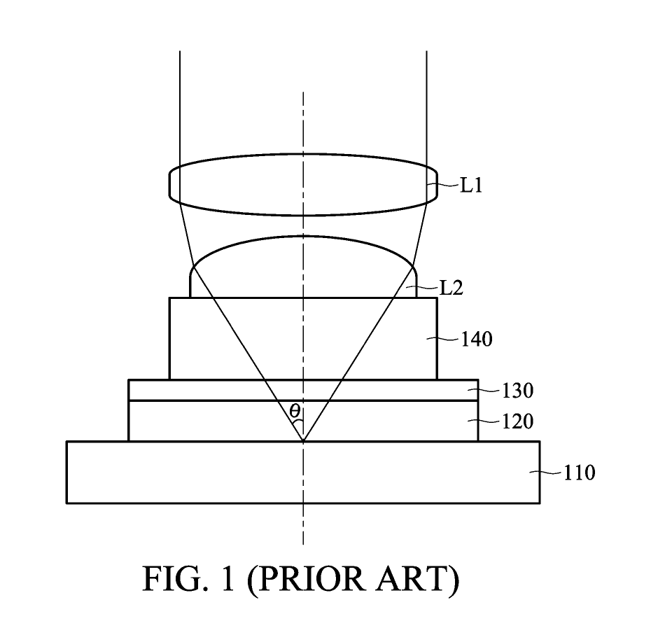

### DETAILED DESCRIPTION OF THE INVENTION

It is to be understood that the following disclosure provides many different embodiments, or examples, for implementing different features of various embodiments. Specific examples of components and arrangements are described below to simplify the present disclosure. These are merely examples and are not intended to be limiting. In addition, the present disclosure may repeat reference numerals and/or letters in the various examples. This repetition is for the purpose of simplicity and clarity and does not in itself indicate a relationship between the various embodiments and/or configurations discussed. Moreover, the formation of a first feature over or on a second feature in the description that follows may include embodiments in which the first and second features are formed in direct contact or not in direct contact.

Embodiments of the invention provide specially designed immersion lithographic apparatuses to bridge a refractive index gap between a projection optical lens, filling media, a capping layer, a photoresist layer and a substrate. Specifically, multiple layers of media of gases, liquids, or liquid crystals partitioned by moveable plates arranged in sequence between the projection system and the substrate structure bridge the refractive index gap, thereby providing a high resolution. Meanwhile, due to narrowing the refractive index gap between the projection optical lens, multiple layers of media, the capping layer, the photoresist layer and the substrate, the absorption condition of the lithographic system is also improved.

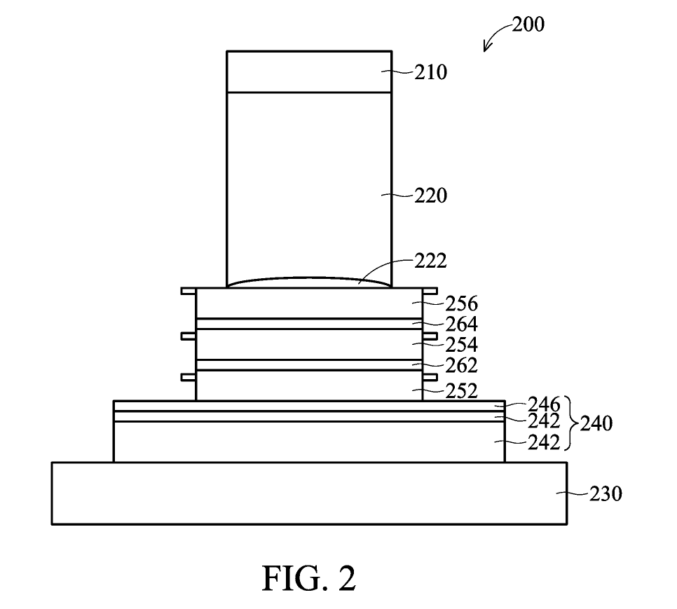

FIG. 2 is a schematic view of an embodiment of an apparatus for immersion lithography with multiple layers of media partitioned by moveable plates. Referring to FIG. 2, an apparatus 200 for gradient immersion lithography includes a radiation system 210 providing a patterned beam of radiation, for example, a deep ultraviolet wavelength (e.g., about 248 nm or about 193 nm), or a vacuum ultraviolet (VUV) wavelength (e.g., about 157 nm). Note that other wavelengths (e.g., an extreme ultraviolet wavelength) may be provided and are also considered to fall within the scope of the invention described and claimed herein. A substrate table 230 is arranged for holding a substrate structure 240. A projection system 220 with an optical lens element 222 is arranged to project a patterned beam of radiation onto the substrate structure 240. Multiple layers of media of gases, liquids, or liquid crystals 252, 254, and 256 partitioned by moveable plates 262 and 264 are arranged in sequence between the projection system 220 and the substrate structure 240, wherein an effective refraction index of the media 252, 254, and 256 bridges a gap of refraction index between the optical lens element 222 and the substrate structure 240. A controller for displacement of the moveable plates 262 and 264 are provided to adjust relative thicknesses of the multiple layers of media 252, 254, and 256.

According to an embodiment of the invention, the multiple layers of media comprise a first media 256, a second media 254, and a third media 252, wherein the optical lens element 222 is immersed in the first media 256 and the substrate 240 is immersed in the third media 242. In another embodiment, the thickness of each fluid can be adjusted according to an absorption coefficient of a corresponding fluid to improve light flux reaching the substrate. Note that refraction indices of the media can be variable. For example, the refraction index of the second fluid 254 can be greater than the refraction index of the first fluid 252. The media can be liquid type such as de-ionized water, a mixture of phosphoric acid (H₃PO₄) and water, a phosphoric acid solution, “Delphi”, which is available from Mitsui Chemical, oil (e.g., perfluorinated polyethers (PFPE)) or other liquids having a refractive index that is greater than 1.4 at a wavelength of 193 nm or 157 nm. The media can also be gases or liquid crystals for special purpose immersion requirement. As another example, the optical lens element 222 can be formed of fused silica or CaF₂, commonly used in 157 nm lithography, and have an index of refraction n ranging from 1.4 to 1.56.

In another embodiment, the moveable plates comprise an upper plate 264 and a lower plate 262 which are adjusted to contain the second media 254 therebetween. The substrate structure 240 may include a wafer 242 with coating layers thereon. The coating layers may comprise a capping layer 246, a photoresist layer 242, an antireflection coating (ARC), or a back antireflection coating (BARC).

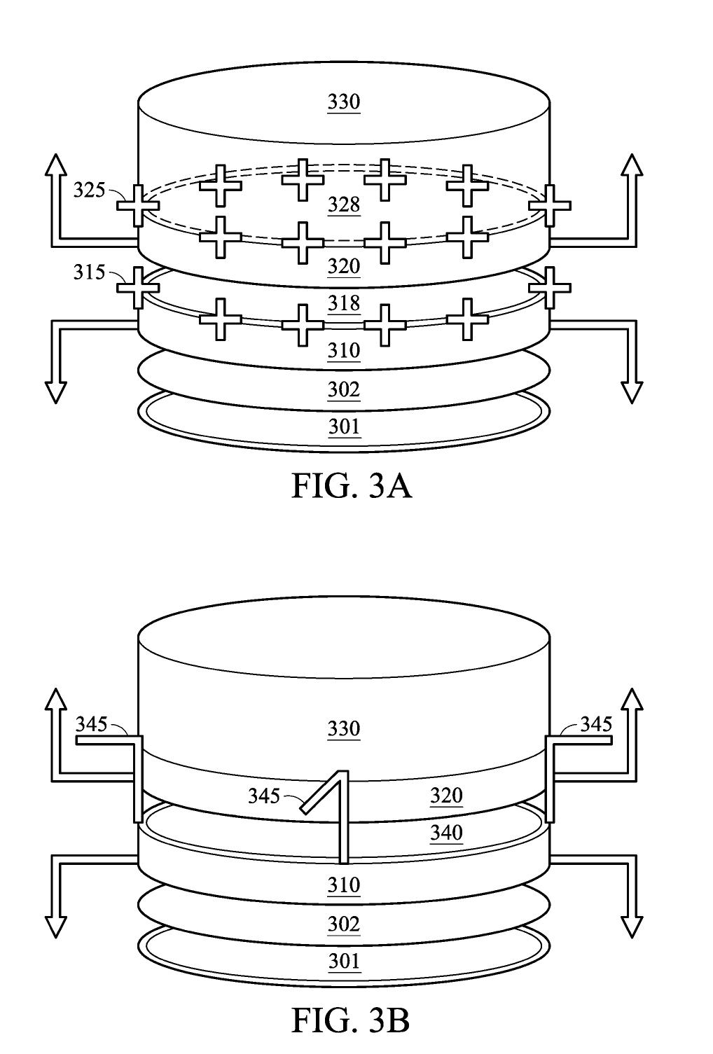

FIG. 3A is a schematic view of an embodiment of electromagnetic placement of the moveable plates of the invention. In FIG. 3A, the control element may include an electrical or magnetic control means for displacement of the moveable plates, wherein the electrical/magnetic control means provides a first charge ring/magnetic poles 325 on the lens 330 and a second charge ring 315 on the moveable plates 318. By controlling the charge rings/magnetic poles 315 and 325, the relative thickness of the first media 320 and the second media 310 can be adjusted according to different absorption conditions. For example, maximum light flux can reach the coating layer 302 on the wafer 301, thereby improving resolution of the lithographic apparatus. In another embodiment, the control element may alternatively include a mechanical control means for displacement of the moveable plates, wherein the mechanical control means includes a plurality of tiny rods 345 moved by a belt or a gear wheel, as shown in FIG. 3B.

Embodiments of the apparatuses for gradient immersion lithography with multiple layers of media partitioned by moveable plates are advantageous in that the multiple layers of media can bridge the gap of refractive index between the optical lens element and the substrate. Design and material of the optical lens elements can develop towards higher refraction index to achieve higher resolution. Furthermore, by controlling the position of the movable plates, thickness of the media can be controlled corresponding to different absorption coefficient. Note that more than one or more movable plates can be provided for partition of media between the optical lens element and the substrate.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An apparatus for gradient immersion lithography, comprising:
a radiation system providing a patterned beam of radiation;
a substrate table with a substrate structure held thereon;
a projection system with an optical lens element arranged to project the patterned beam of radiation onto the substrate structure;
multiple layers of media of gases, liquids, or liquid crystals partitioned by moveable plates arranged in sequence between the projection system and the substrate structure; and
a control element adjusting relative positions of the moveable plates.

2. The apparatus for gradient immersion lithography as claimed in claim 1, wherein the multiple layers of media comprise a first media, a second media, and a third media, and wherein the optical lens element is immersed in the first media and the substrate is immersed in the third media.

3. The apparatus for gradient immersion lithography as claimed in claim 2, wherein a thickness of each media is adjustable according to an absorption coefficient of a corresponding media.

4. The apparatus for gradient immersion lithography as claimed in claim 2, wherein a second refraction index of the second media is greater than a first refraction index of the first media.

5. The apparatus for gradient immersion lithography as claimed in claim 2, wherein a second refraction index of the second media is less than a third refraction index of the third media.

6. The apparatus for gradient immersion lithography as claimed in claim 2, wherein the moveable plates comprise an upper plate and a lower plate adjusted to contain the second media therebetween.

7. The apparatus for gradient immersion lithography as claimed in claim 1, wherein the substrate structure comprises a wafer with coating layers thereon.

8. The apparatus for gradient immersion lithography as claimed in claim 1, wherein the coating layers comprise a capping layer, a photoresist layer, an antireflection coating, or a back antireflection coating.

9. The apparatus for gradient immersion lithography as claimed in claim 1, wherein the control element comprises an electrical/magnetic control means for displacement of the moveable plates, wherein the electrical/magnetic control means provides a first charge ring/magnetic poles on the lenses and a second charge ring/magnetic poles on the moveable plates.

10. The apparatus for gradient immersion lithography as claimed in claim 1, wherein the control element comprises a mechanical control means for displacement of the moveable plates, wherein the mechanical control means includes a plurality of tiny rods moved by a belt or a gear wheel.

11. An apparatus for gradient immersion lithography, comprising:
a radiation system providing a patterned beam of radiation;
a substrate table with a substrate structure held thereon;
a projection system with an optical lens element arranged to project the patterned beam of radiation onto the substrate structure;
multiple layers of media partitioned by moveable plates arranged in sequence between the projection system and the substrate structure, wherein an effective refraction index of the media bridges a gap of refraction index between the optical lens element and the substrate structure; and
a controller for displacement of the moveable plates to electrically or mechanically control relative thicknesses of the multiple layers of media.

12. The apparatus for gradient immersion lithography as claimed in claim 11, wherein the multiple layers of media comprise a first media, a second media, and a third media, and wherein the optical lens element is immersed in the first media and the substrate is immersed in the third media.

13. The apparatus for gradient immersion lithography as claimed in claim 12, wherein a thickness of each media is adjustable according to an absorption coefficient of a corresponding fluid.

14. The apparatus for gradient immersion lithography as claimed in claim 12, wherein a second refraction index of the second media is greater than a first refraction index of the first media.

15. The apparatus for gradient immersion lithography as claimed in claim 12, wherein a second refraction index of the second media is less than a third refraction index of the third media.

16. The apparatus for gradient immersion lithography as claimed in claim 12, wherein the moveable plates comprise an upper plate and a lower plate adjusted to contain the second fluid therebetween.

17. The apparatus for gradient immersion lithography as claimed in claim 11, wherein the substrate structure comprises a wafer with coating layers thereon.

18. The apparatus for gradient immersion lithography as claimed in claim 11, wherein the coating layers comprise a capping layer, a photoresist layer, an antireflection coating, or a back antireflection coating.

19. The apparatus for gradient immersion lithography as claimed in claim 11, wherein the controller is an electrical/magnetic control device, wherein the electrical/magnetic control means provides a first charge ring/magnetic pole on the lenses and a second charge ring/magnetic pole on the moveable plates.

20. The apparatus for gradient immersion lithography as claimed in claim 1, wherein the controller is a mechanical control device and the mechanical control means includes a plurality of tiny rods moved by a belt or a gear wheel.
